(19) United States
(12) Patent Application Publication
(10) Pub. No.: US 2017/0342357 A1
(43) Pub. Date: Nov. 30, 2017

(54) Water-Soluble Unit Dose Article Comprising A Bleach Catalyst

(71) Applicant: The Procter & Gamble Company, Cincinnati, OH (US)

(72) Inventors: Neil Joseph Lant, Newcastle upon Tyne (GB); Stefano Scialla, Strombeek-Bever (BE); Linsey Sarah Fuller, Newcastle upon Tyne (GB); Robby Renilde Francois Keuleers, Lippelo (Sint Amands) (BE); Alan Thomas Brooker, Newcastle upon Tyne (GB)

(21) Appl. No.: 15/596,311

(22) Filed: May 16, 2017

(30) Foreign Application Priority Data
May 26, 2016 (EP) 16171594.1

(51) Int. Cl. C11D 17/04; C11D 3/39; C11D 3/08; C11D 3/37; C11D 3/10; C11D 11/00; C11D 3/04

(52) U.S. Cl. CPC C11D 17/045; C11D 11/0017; C11D 3/3945; C11D 3/3942; C11D 3/392; C11D 3/046; C11D 3/3753; C11D 3/10; C11D 3/08; C11D 3/3915

(57) ABSTRACT

Water-soluble unit dose articles including a bleach catalyst and methods of their use.

### FIELD OF THE INVENTION

The present invention related to water-soluble unit dose articles comprising a bleach catalyst and methods of their use.

### BACKGROUND OF THE INVENTION

Water-soluble unit dose articles are liked by consumers as being convenient and efficient to use. They comprise a single unit dose of a cleaning or treatment composition that can be added to water to create a suitable wash liquor.

Formulation of bleaching ingredients into the cleaning or treatment composition provides beneficial cleaning benefits. However, the compacted nature of the unit dose article means there is not a lot of space within the composition for addition of ingredients. In other words, a high concentration of one ingredient needed to provide a particular benefit is at the cost of the level or one or more ingredients due to the limited formulation space due to the compacted design.

Therefore, there is a need in the art for a bleach system which enables overall lower bleach ingredient levels in the unit dose article yet minimises reduction in bleach cleaning performance due to the lower ingredient levels.

It was surprisingly found that a water-soluble unit dose article comprising an acyl hydrazone bleach catalysts according to the present invention overcame this technical problem.

In addition it was surprisingly found that the presence of the acyl hydrazone bleach catalyst provided improved bleach cleaning in lower pH conditions. Without wishing to be bound by theory, bleach ingredients provide improved bleach cleaning at higher pHs. Therefore, it is preferential to formulate with materials that ensure the wash liquor has optimal higher pH for bleach performance. However, due to the compacted nature of water-soluble unit dose forms there is not enough formulation space to provide the high levels of alkaline materials necessary to effect the higher pH wash liquor. It was surprisingly found that this issue was overcome by the use of the acyl hydrazone bleach catalysts which provided improved bleach performance at lower pH removing the necessity for the formulation of high levels of ingredients necessary to effect high pH conditions in the wash liquor.

### SUMMARY OF THE INVENTION

A first aspect of the present invention is a water-soluble unit dose article comprising a water-soluble film and a first laundry cleaning or care composition, wherein said first composition comprises an acyl hydrazone bleach catalyst.

A second aspect of the present invention is a process of washing fabrics comprising the steps of diluting a water-soluble unit dose article according to the present invention in sufficient water to dilute the first composition between 300 and 800 fold to form a wash liquor and contacting fabrics to be washed with said wash liquor.

### DETAILED DESCRIPTION OF THE INVENTION

### Water-Soluble Unit Dose Article

The water-soluble unit dose article of the present invention comprises a water-soluble film and a first laundry cleaning or care composition. The water-soluble film and first composition are described in more detail below.

The water-soluble unit dose article comprises at least one water-soluble film shaped such that the unit-dose article comprises at least one internal compartment surrounded by the water-soluble film. The at least one compartment comprises the first laundry cleaning or care composition. The water-soluble film is sealed such that the first laundry cleaning or care composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the first laundry cleaning or care composition. The unit dose article is manufactured such that the water-soluble film completely surrounds the first laundry cleaning or care composition and in doing so defines the compartment in which the first laundry cleaning or care composition resides. The unit dose article may comprise two films. A first film may be shaped to comprise an open compartment into which the first laundry cleaning or care composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

The first and second compartments maybe positioned side-by-side to one another, preferably wherein the first and second compartments are separated by a bridge region. The ‘bridge region’ is comprised of the film material and separates the two compartments from one another but allows the first compartment to stay attached to the second compartment and vice versa.

In a multi-compartment orientation, the first laundry cleaning or care composition according to the present invention may be comprised in at least one of the compartments. It may for example be comprised in just one compartment, or may be comprised in two compartments, or even in three compartments.

Each compartment may comprise the same or different compositions. The different compositions could all be in the same form, or they may be in different forms.

Preferably, the unit dose article comprises at least a first internal compartment and a second internal compartment and wherein the first compartment comprises the first composition and the second compartment preferably comprises a second composition wherein preferably the second composition is a liquid.

The water-soluble may comprise a source of hydrogen peroxide. Preferably, the hydrogen peroxide source is selected from alkali metal perborates, alkali metal percarbonates, urea perhydrates, peroxycarboxylic acids, alkali metal persulfates, alkali metal peroxydisulfates, Caroates, diacyl peroxides, tetraacyl diperoxides or a mixture thereof, pre preferably percarbonate. The hydrogen peroxide source may be comprised in the first laundry cleaning or care composition.

Alternatively, the hydrogen peroxide may be present in a second laundry cleaning or care composition.

The water-soluble unit dose article may comprise between 5% and 35%, preferably between 6% and 30%, more preferably between 7% and 25% by weight of the first composition of the hydrogen peroxide source.

### First Laundry Cleaning or Care Composition

The first laundry cleaning or care composition comprises an acyl hydrazone bleach catalyst. The acyl hydrazone bleach catalyst is described in more detail below.

The first laundry cleaning or care composition may be in the form of a free flowing powder, a liquid, a compacted solid, a gel or a mixture thereof. Preferably, the first laundry cleaning or care composition is in the form of a free flowing powder. Such a free flowing powder may have an average particle size diameter of between 100 microns and 1500 microns, preferably between 100 microns and 1000 microns, more preferably between 100 microns and 750 microns. Those skilled in the art will be aware of standard techniques to measure particle size.

The first laundry cleaning or care composition may comprise a source of alkalinity, preferably wherein the first laundry cleaning or care composition has a reserve alkalinity of greater than 3, preferably greater than 6.5, more preferably greater than 7.5, most preferably greater than 9.

As used herein, the term “reserve alkalinity” is a measure of the buffering capacity of the detergent composition (g/NaOH/100 g detergent composition) determined by titrating a 1% (w/v) solution of detergent composition with hydrochloric acid to pH 7.5 i.e in order to calculate Reserve Alkalinity as defined herein:

$$Reserve alkalinity ( to pH 7.75 as \% alkali in g NaOH per 100 g product = \frac{T \times M \times 40 \times Vol}{10 \times Wt \times Aliquot}$$

T=titre (ml) to pH 7.5

M=Molarity of HCl=0.2

40=Molecular weight of NaOH

Vol=Total volume (ie. 1000 ml)

W=Weight of product (10 g)

Aliquot=(100 ml)

Those skilled in the art will know how to measure reserve alkalinity using standard techniques. A preferred method is to obtain a 10 g sample accurately weighed to two decimal places, of fully formulated detergent composition. The sample is preferably obtained using a Pascall sampler in a dust cabinet. Add the 10 g sample to a plastic beaker and add 200 ml of carbon dioxide-free deionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls 1 ml aliquot using a 100 mls pipette immediately. Measure and record the pH and temperature of the sample using a pH meter capable of reading to _0.01 pH units, with stirring, ensuring temperature is 21° C.+/−2° C. Titrate whilst stirring with 0.2M hydrochloric acid until pH measures exactly 7.5.

Note the millilitres of hydrochloric acid used. Take the average titre of three identical repeats. Carry out the calculation described above to calculate RA to pH 7.5.

The source of alkalinity is preferably selected from alkali metal carbonates, alkali metal bicarbonates, alkali metal silicates, alkali metal sulphates or a mixture thereof.

The first laundry cleaning or care composition may comprise an adjunct ingredient. Preferably, the adjunct ingredient is selected from TAED, soap, brightener, carboxymethylcellulose, enzymes, soil release polymer, surfactant, citrate, HEDP, 8-hydroxyquinoline sulphonic acid, dihydroxyterephthalic acid derivatives or a mixture thereof.

The first laundry cleaning or care composition may comprise a source of hydrogen peroxide. Preferably, the hydrogen peroxide source is selected from alkali metal perborates, alkali metal percarbonates, urea perhydrates, peroxycarboxylic acids, alkali metal persulfates, alkali metal peroxydisulfates, Caroates, diacyl peroxides, tetraacyl diperoxides or a mixture thereof. The water-soluble unit dose article may comprise between 5% and 30%, preferably between 6% and 25%, more preferably between 7% and 20% by weight of the first composition of the hydrogen peroxide source.

### Acyl Hydrazone Bleach Catalyst

The first cleaning or care composition comprises an acyl hydrazone bleach catalyst. Preferably, the first composition comprises between 0.001% and 1%, preferably between 0.01% and 0.75%, more preferably between 0.1% and 0.5% by weight of the composition of the acyl hydrazone bleach catalyst.

Preferably, the acyl hydrazone bleach catalyst has the formula I;

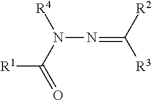

wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof.

More preferably, the acyl hydrazone bleach catalyst is 4-(2-(2-((2-hydroxyphenylmethyl)methylene)-hydrazinyl)-2-oxoethyl)-4-methylchloride having the formula II;

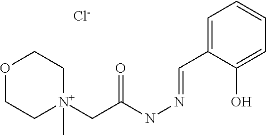 [SMILES: C[N+]1(CC(=O)N/N=C/c2ccccc2O)CCOCC1 ; [Cl-]]

Acyl hydrazone bleach catalysts boost the bleaching action of peroxidic bleaching agents, without unduly damaging the substrate to be cleaned, for example the fabric. The peroxidic bleaching agents are preferably H₂O₂ or substances that release H₂O₂ in water, including in particular alkali metal perborates, alkali metal percarbonates and urea perhydrates; however, they may be also possibly employed combined with peroxycarboxylic acids, such as diperoxydecanedicarboxylic acid or phthalimido peroxycaproic acid, with other acids or acidic salts, such as alkali metal persulfates or alkali metal peroxydisulfates or Caroates, or with diacyl peroxides or tetraacyl diperoxides.

Acyl hydrazones may be processed into the detergent in the form of a granulate. The granulate may be a two-layer coated granulate comprising;
a) a core pellet comprising 5 to 40% by weight based on the weight of the total granule of an acyl hydrazone of formula (I) and 1-10% by weight based on the weight of the total granule of water and/or water soluble binder which is selected from the group consisting of polyvinylalcohols, polyvinylpyrrolidones, polyacrylates, cellulose derivatives, carbohydrates, polyethyleneglycols and mixtures thereof;
b) 0.1% to 25% by weight based on the weight of the total granule of a subcoating comprising a polymer mixture of hydoxypropylmethylcellulose (HPMC) and methylcellulose (MC) in a ratio by weight of from 2:1 to 8:1;
c) 1 to 25% by weight based on the weight of the total granule of a topcoating comprising a fatty acid selected from nonadecanoic acid, stearic acid, palmitic acid, myristic acid and mixtures thereof; and
d) other components
   the sum of components (a) to (d) adding to 100%.

Preferably, the acyl hydrazone bleach catalyst is comprised within a granule, wherein preferably the granule comprises between 5% and 40% by weight of the granule of the acyl hydrazone bleach catalyst.

### Water-Soluble Film

The unit dose article comprises a water-soluble film. Preferably, the water-soluble film comprises a polyvinylalcohol.

The film of the present invention is soluble or dispersible in water. The water-soluble film preferably has a thickness of from 20 to 150 micron, preferably 35 to 125 micron, even more preferably 50 to 110 micron.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the film material. This can be beneficial to control the mechanical and/or dissolution properties of the compartments or unit dose article, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films are those supplied by Monosol under the trade references M8630, M8900, M8779, M8310.

Of the total PVA resin content in the film described herein, the PVA resin can comprise 30 to 85 wt % of the first PVA polymer, or 45 to 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Process of Making

Those skilled in the art will be aware of standard methods and techniques to make the first laundry cleaning or care composition.

Those skilled in the art will be aware of standard techniques to make the unit dose article. Standard forming processes including but not limited to thermoforming and vacuum forming techniques may be used.

### Process of Washing

One aspect of the present invention is a process of washing fabrics comprising the steps of contacting the unit dose article of the present invention with sufficient water to dilute the first laundry cleaning or care between 300 and 800 fold to form a wash liquor, and contacting fabrics to be washed with said wash liquor.

The unit dose article of the present invention can be added to a wash liquor to which laundry is already present, or to which laundry is added. It may be used in an automatic washing machine operation and added directly to the drum or to the dispenser drawer. It may be used in combination with other laundry detergent compositions such as fabric softeners or stain removers.

Preferably the wash liquor has a pH of between 6.5 and 12, more preferably between 7 and 9.

### EXAMPLES

A unit dose article comprising a water-soluble PVOH film, preferably M8630 film commercially available from Monosol and between 7 g and 10 g of a free-flowing powder laundry cleaning or care composition comprising;

| | Wt % by weight of the |
|---|---|
| | laundry cleaning or |
| Ingredient | care composition |
| Percarbonate | 25%-35% |
| TAED | 7%-12% |
| 4-(2-(2-((2-hydroxyphenylmethyl)methylene)- | 0.001%-1% |
| hydrazinyl)-2-oxoethyl)-4-methylchloride | |
| Soap | 2%-5% |
| Brightener 49 | 0.01%-2% |
| Carboxymethylcellulose | 5%-12% |
| Sodium carbonate | 2%-6% |
| Sodium bicarbonate | 6%-14% |
| Sodium silicate | 6%-12% |
| Sulphate | 6%-12% |
| Water | 1%-4% |
| Enzymes, colourants, perfumes and other | Up to 100% |
| common laundry detergent ingredients | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble unit dose article comprising a water-soluble film and a first laundry cleaning or care composition, wherein said first composition comprises an acyl hydrazone bleach catalyst.

2. The water-soluble unit dose article according to claim 1 wherein the acyl hydrazone bleach catalyst has the formula I; 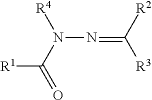
wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof.

3. The water-soluble unit dose article according to claim 2 wherein the acyl hydrazone bleach catalyst is 4-(2-(2-((2-hydroxyphenylmethyl)methylene)-hydrazinyl)-2-oxoethyl)-4-methylchloride having the formula II;

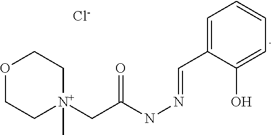 [SMILES: C[N+]1(CC(=O)N/N=C/c2ccccc2O)CCOCC1 ; [Cl-]]

4. The water-soluble unit dose article according to claim 1 wherein the first laundry cleaning or care composition comprises between about 0.001% and about 1%, by weight of the composition of the acyl hydrazone bleach catalyst.

5. The water-soluble unit dose article according to claim 4 wherein the first laundry cleaning or care composition comprises between about 0.01% and about 0.75%, by weight of the composition of the acyl hydrazone bleach catalyst.

6. The water-soluble unit dose article according to claim 5 wherein the first laundry cleaning or care composition comprises between about 0.1% and about 0.5% by weight of the composition of the acyl hydrazone bleach catalyst.

7. The water-soluble unit dose article according to claim 1 wherein the first laundry cleaning or care composition is in the form of a free flowing powder, a liquid, a compacted solid, a gel or a mixture thereof.

8. The water-soluble unit dose article according to claim 7 wherein the laundry cleaning or care composition is in the form of a free flowing powder.

9. The water-soluble unit dose article according to claim 8 wherein the acyl hydrazone bleach catalyst is comprised within a granule, wherein the granule comprises between about 5% and about 40% by weight of the granule of the acyl hydrazone bleach catalyst.

10. The water-soluble unit dose article according to claim 1 comprising a source of hydrogen peroxide.

11. The water-soluble unit dose article according to claim 10 comprising a source of hydrogen peroxide, wherein the hydrogen peroxide source is selected from alkali metal perborates, alkali metal percarbonates, urea perhydrates, peroxycarboxylic acids, alkali metal persulfates, alkali metal peroxydisulfates, Caroates, diacyl peroxides, tetraacyl diperoxides or a mixture thereof.

12. The water-soluble unit dose article according to claim 10 comprising between about 5% and about 35%, by weight of the first composition of the hydrogen peroxide source.

13. The water-soluble unit dose article according to claim 1 wherein the first laundry cleaning or care composition comprises a source of alkalinity.

14. The water-soluble unit dose article according to claim 13 wherein the first laundry cleaning or care composition comprises a source of alkalinity, wherein the first laundry cleaning or care composition has a reserve alkalinity of greater than 3.

15. The water-soluble unit dose article according to claim 13 wherein the source of alkalinity is selected from alkali metal carbonates, alkali metal bicarbonates, alkali metal silicates, alkali metal sulphates or a mixture thereof.

16. The water-soluble unit dose article according to claim 1 wherein the first laundry cleaning or care composition comprises an adjunct ingredient wherein the adjunct ingredient is selected from TAED, soap, brightener, carboxymethylcellulose, enzymes, soil release polymer, surfactant, citrate, HEDP, 8-hydroxyquinoline sulphonic acid, dihydroxyterephthalic acid derivatives or a mixture thereof.

17. The unit dose article according to claim 1 wherein the water-soluble film comprises a polyvinylalcohol.

18. The unit dose article according to claim 1 comprising at least a first internal compartment and a second internal compartment and wherein the first compartment comprises the first laundry cleaning or composition and the second compartment comprises a second composition.

19. The unit dose article according to claim 18 wherein the second composition is a liquid.

20. A process of washing fabrics comprising the steps of diluting a water-soluble unit dose article according to claim 1 in sufficient water to dilute the first laundry cleaning or care composition between about 300 and about 800 fold to form a wash liquor and contacting fabrics to be washed with said wash liquor.
